(19) United States
(12) Patent Application Publication
(10) Pub. No.: US 2016/0299782 A1
(43) Pub. Date: Oct. 13, 2016

(54) SYSTEM AND METHOD FOR DETERMINING A SEQUENCE FOR PERFORMING A PLURALITY OF TASKS

(71) Applicant: Wal-Mart Stores, Inc., Bentonville, AR (US)

(72) Inventors: Nicholaus Adam Jones, Fayetteville, AR (US); Matthew Allen Jones, Bentonville, AR (US); Robert James Taylor, Rogers, AR (US)

(21) Appl. No.: 15/053,480

(22) Filed: Feb. 25, 2016

Related U.S. Application Data
(60) Provisional application No. 62/145,076, filed on Apr. 9, 2015.

(51) Int. Cl. G06F 9/50

(52) U.S. Cl. CPC G06F 9/50

(57) ABSTRACT

Disclosed herein is a system and method for determining a sequence for a plurality of tasks, such as tasks assigned to an employee by an employer. The system associates a location identifier to each task, and generates a proposed sequence for the plurality of tasks. The disclosed system receives task performance data that provides information on the actual sequence that was used to perform the plurality of tasks. The task performance data is used to determine a performed sequence—the sequence used by the employee to perform the plurality of tasks. The system compares the performed sequence to the proposed sequence. The system may score the proposed sequence and the performed sequence using a plurality of weighted factors. The system for determining a sequence for a plurality of tasks uses the proposed sequence and the performed sequence to generate proposed sequences for future pluralities of tasks.

### CROSS REFERENCE TO RELATED APPLICATION

This application claims priority to U.S. Provisional Patent Application Ser. No. 62/145,076 to Walmart Stores Inc., filed Apr. 9, 2015 and entitled “System and Method For Determining a Sequence for Performing a Plurality of Tasks”, which is hereby incorporated entirely herein by reference.

### FIELD OF THE INVENTION

The invention relates generally to task management systems, and more particularly to a system and method for determining a sequence for performing a plurality of tasks.

### BACKGROUND

Employees in retail stores and warehouses are often provided with a list of tasks to perform. It is often in the best interest of the employer, and often the employee, to have the tasks performed as quickly as possible, and as safely as possible. Employees are often provided with the list of tasks, but the list may not be in a sequence that will minimize the time needed to complete the tasks, maximize the safety, or take into account other factors that may be important to the employee or the employer when performing tasks. An employee can be told to complete the tasks as quickly and safely as possible, but an employee may be unable or unwilling to determine a sequence for the tasks that will account for time and safety efficiently. It is desirable to have a system that will provide a sequenced task list for an employee, collect information on the time and actual sequence the employee uses to complete the task list, and use the information regarding the sequence and the time the tasks were performed to optimize sequences for future task lists. It is also desirable to have a system that is capable of generating sequences that take into account not only safety and speed of execution, but also other factors important to employer and employee when developing a sequence for performing a plurality of tasks.

### BRIEF SUMMARY

In one aspect, provided is a computer system for determining a sequence for a plurality of tasks. The computer system for determining the sequence for a plurality of tasks includes a sequence determination utility that generates a proposed sequence for performing a first plurality of tasks. The computer system also includes a performed sequence utility that stores in memory a performed sequence, where the performed sequence is the sequence used to perform the first plurality of tasks. The sequence determination utility uses the performed sequence to generate a proposed sequence for performing a second plurality of tasks.

In another aspect, disclosed is a system for providing a sequenced task list. The system includes a computer system for determining the sequence for a plurality of tasks. The computer system outputs a sequenced task list comprising a plurality of tasks, a location identifier associated with each of the plurality of tasks, and a proposed sequence for performing the plurality of tasks. An employee receives the sequenced task list and performs the plurality of tasks. Task performance data is provided as feedback to the computer system, where the task performance data is data regarding the actual sequence the employee uses to perform the plurality of tasks. The computer system uses the task performance data to determine a performed sequence, and uses the performed sequence to generate proposed sequences for future pluralities of tasks.

In another aspect, provided is a method for generating a sequence for a plurality of tasks. The method includes generating a proposed sequence for a first plurality of tasks. The method also includes determining a performed sequence, where the performed sequence is the sequence used to perform the first plurality of tasks. The method for generating a sequence for a plurality of tasks also includes comparing the performed sequence to the proposed sequence for the first plurality of tasks, and using the performed sequence to generate a proposed sequence for a second plurality of tasks.

In another aspect, disclosed is a system for providing a sequenced task list. The system includes a means for assigning a proposed sequence score to a proposed sequence for performing a first plurality of tasks and a means for assigning a performed sequence score to a performed sequence. The performed sequence is the sequence used to perform the first plurality of tasks. The system also includes a means for comparing the performed sequence score and the proposed sequence score. In some embodiments, the means for comparing sets the proposed sequence equal to the performed sequence in response to the performed sequence score being greater than the proposed sequence score.

### BRIEF DESCRIPTION OF THE SEVERAL VIEWS OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a system for providing a sequenced task list.

FIG. 2 illustrates a sequenced task list including a plurality of tasks, a location identifier associated with each task, and a proposed sequence for the plurality of tasks.

FIG. 3 is an illustrative view of a route used to perform the plurality of tasks of FIG. 2.

FIG. 4 is an illustrative view of another route used to accomplish the plurality of tasks of FIG. 2.

FIG. 5 illustrates the sequenced task list of FIG. 2 and a performed sequence for the plurality of tasks.

FIG. 6 is a block diagram illustrating a system for generating a sequence for a plurality of tasks.

FIG. 7 is a block diagram illustrating further details of the system for generating a sequence for a plurality of tasks of FIG. 6.

FIG. 8 illustrates an embodiment of a sequence comparison flowchart use by a sequence comparison utility to compare a proposed sequence to a performed sequence.

FIG. 9 illustrates embodiments of sequence scoring equations.

FIG. 10 illustrates a method of generating a sequence for a plurality of tasks.

### DETAILED DESCRIPTION

Disclosed herein is a system and method for determining a sequence for a plurality of tasks. The plurality of tasks are often tasks assigned to employees, for example employees of retail stores and warehouses. The system associates a location identifier to each task of the plurality of tasks, and generates a proposed sequence for the plurality of tasks. The location identifier indicates where each task is to be performed. Employees performing the tasks are provided with a mobile computing device and instructed to use the mobile computing device to record a time stamp for each task performed. The time stamp indicates the time that each task is performed by the employee. Employees are provided with a proposed sequence, but are instructed to use their own judgment and change the task sequence if they think they can improve the sequence. The disclosed system receives task performance data that provides information on the actual sequence that was used by the employee to perform the task list. The task performance data includes the time stamps reflecting when each task was performed, and may include additional data relating to the performed sequence. The task performance data gathered from the employees' completion of the plurality of tasks is used to determine a performed sequence—the sequence used by the employee to perform the plurality of tasks. The system compares the performed sequence to the proposed sequence. The disclosed system for determining a sequence for a plurality of tasks uses the proposed sequence and the performed sequence to generate proposed sequences for later task lists. In some embodiments, the system scores the proposed sequence and the performed sequence using a plurality of weighted factors. The weighted factors can represent qualities important to an employer or an employee when determining task sequences, such as speed, safety, accuracy, etc.

Task lists are often provided to employees as a way of assigning work. For employees of retail stores, warehouses, and other similar types of work establishments, the task lists often include a plurality of tasks to be performed, and a location of where each task is to be performed. It is often in the employer's interest that the employee completes the tasks as quickly as possible, but to also uphold safety standards while performing the tasks. It is not in an employer's or an employee's best interest for an employee to undertake unsafe routes or practices while completing a task list. There are often other considerations besides speed and safety that an employer takes into account when determining the order of performing tasks and the route taken to complete the tasks.

Often employees are provided with either a specified route to use to perform the tasks, or an assigned sequence used to perform the tasks, or both. A sequence is the order that the tasks are performed in, and a route is the physical route that is taken by the employee when traveling from one task to the next. Determining an optimal route or sequence can be costly for an employer. Time studies may be needed, and the safety and timing of many different combinations of routes and locations may need to be analyzed and compared.

Another option is to provide the task list to the employee, and let the employee determine the route to be used. Employees may be unable or unwilling, however, to determine an optimum route and/or sequence to use in performing tasks. What is needed is a system for collecting data from many employees on the sequences used to perform tasks, and the time required to move between tasks for particular sequences and locations. Task performance data is recorded as the employee performs tasks, and does not require separate time studies to be performed by the employer. The disclosed system for generating a sequence for a plurality of tasks collects task performance data and uses the collected data to generate proposed sequences for future task lists. As each task list is completed, the task performance data is added to a database, and used by the system for determining a sequence for a plurality of tasks to generate new proposed sequences.

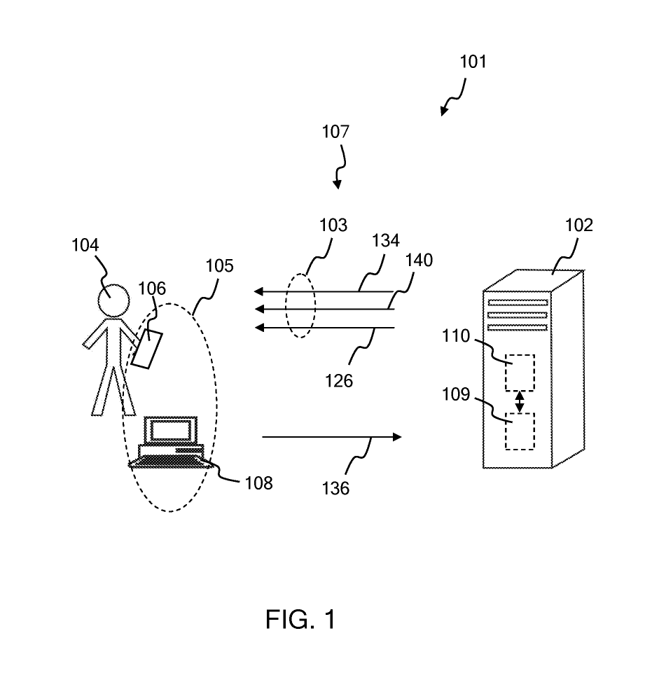

FIG. 1 illustrates a system 101 for providing a sequenced task list 103 to an employee 104. System 101 includes a server 102 that includes a computer system 110 for determining a sequence for a plurality of tasks, and a database 109. In this embodiment, system 110 is a computer program, but it is to be understood that computer system 110 can take many forms and implementations, including hardware, software, or both. System 110 and database 109 are resident on server 102 in this embodiment, but it is to be understood that system 110 and database 109 can be a part of any computational equipment. In a particular embodiment, system 110 is implemented in hardware processors. The hardware processors can be application specific integrated circuits or hardware accelerators, for example. The hardware processors can be part of one or more special purpose computers that execute computer program instructions which implement one or more functions and operations of system 110.

In some embodiments, system 110 and database 109 are separate components. System 110 communicates with employee 104 through communication 107. Communication 107 includes sequenced task list 103 output from computer system 110 to employee 104, and task performance data 136 received from employee 104 and provided to computer system 110 of server 102.

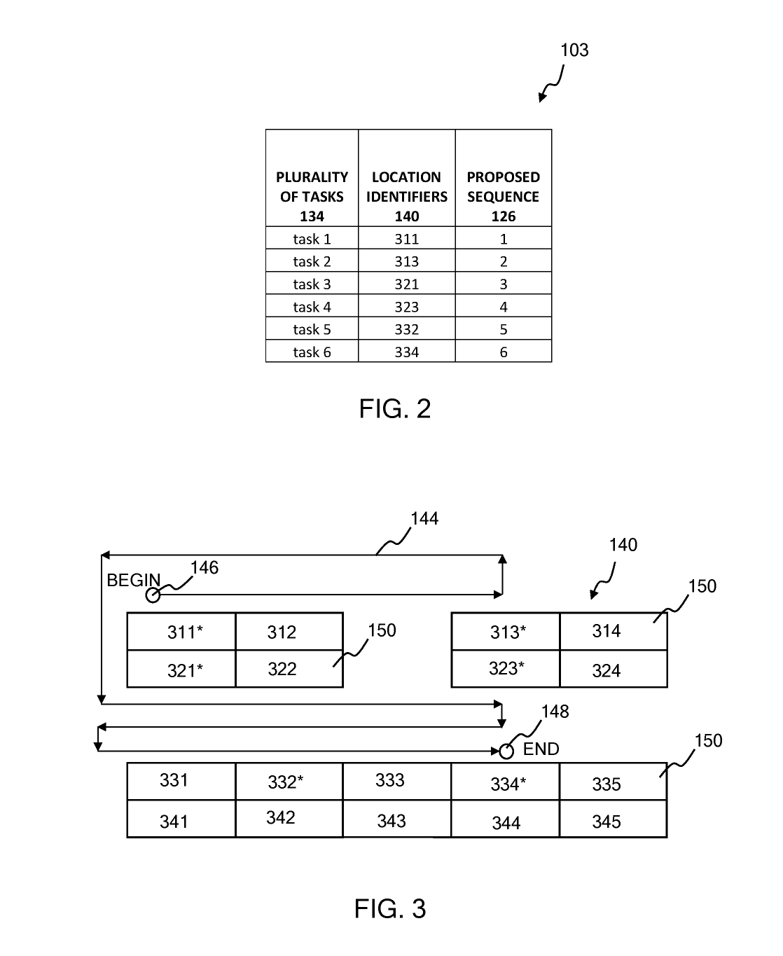

Communication 107 includes sequenced task list 103, an example of which is shown in FIG. 2 in table form. Sequenced task list 103 in this embodiment includes a plurality of tasks 134, a location identifier 140 associated with each of the plurality of tasks 134, and a proposed sequence 126 for performing the plurality of tasks 134. In some embodiments, sequenced task list 103 includes other data. Sequenced task list 103 is output from computer system 110 of server 102 to employee 104.

Referring back to FIG. 1, task performance data 136 is received from employee 104 and input into computer system 110 of server 102. In this embodiment, task performance data 136 includes a time stamp indicating the time each one of plurality of tasks 134 was completed. In some embodiments, input 136 includes other data gathered by or during the execution by employee 104 of plurality of tasks 134. Time that an employee takes a break or is performing other duties is also time stamped and accounted for in task performance data 136.

Communication 107 between employee 104 and system 110, which includes sequenced task list 103 and task performance data 136, can be accomplished in many ways, including internet, intranet, wireless communication, wired, local-area network, or printed paper and scanner communications. In the embodiment shown in FIG. 1, server 102 is a store server connected to the internet and will communicate via the internet with employee 104 via input/output devices 105.

Input/output devices 105 can include many different types of devices suited for employee 104 to communicate with server 102 and computer system 110. In this embodiment, input/output devices 105 includes a portable computing device 106 and a computer 108. Portable computing device 106 is carried by employee 104 while performing plurality of tasks 134. Portable computing device 106 can be any type of portable computing device, including a portable scanner, a portable communicator, a portable computer, etc. In this embodiment, portable computing device 106 is a portable scanner carried by employee 104. Portable computing device 106 is used to provide a “scan”, or time stamp, as each one of plurality of tasks 134 is completed. Portable computing device 106 in this embodiment communicates wirelessly with server 102 and computer system 110. Computer 108 in this embodiment is also used by employee 104 to interface with server 102 and computer system 110. Computer 108 can be used to receive sequenced task list 103, or to enter data that is part of task performance data 136 to be sent as input to computer system 110. Input/output devices 105 can include many other types of devices for communication between employee 104 and computer system 110, including but not limited to computing devices, cellular phones, portable wireless devices, wired computers and keyboards.

Computer system 110 generates sequenced task list 103, which includes plurality of tasks 134, location identifiers 140, and proposed sequence 126 as shown in FIG. 2. Employee 104 receives sequenced task list 103, performs plurality of tasks 134, and generates task performance data 136. Task performance data 136 is used to determine a performed sequence 128 (see FIG. 5). Performed sequence 128 is the sequence used by employee 104 to perform plurality of tasks 134. System 110 uses performed sequence 128 to generate proposed sequences 126 for future pluralities of tasks 134, as explained herein.

FIG. 3 is an illustrative top view of several store shelves 150, showing location indicators 140 and a route 144 that is used to perform plurality of tasks 134. Location indicators 140 are numbers which identify specific locations in shelves 150 of a retail store, for example. In this embodiment each location indicator 140 is a three digit sequence, where the first digit is a department number, the second digit is an aisle number, and the third digit is a modular section number, but this is an example only of specific location indicators and is not meant to be exhaustive. In some embodiments the three digit location indicator represents an aisle number, a rack number, and a height number. In some embodiments, each digit represents other types of location indications. Location indicators 140 can take many forms and have any number of digits or letters. Location indicators 140 can be as simple as a single digit or letter designating a location, or they can be highly precise such as GPS coordinates of a location.

Also shown in FIG. 3, with an asterisk, are the specific location indicators 140 where one of plurality of tasks 134 is to be performed, and a route 144 that can be taken to perform plurality of tasks 134.

Proposed sequence 126 of FIG. 2 is an initial suggested sequence for an employee to use when performing plurality of tasks 134. In this embodiment, proposed sequence 126 puts location indicators 140 in numerical order. Route 144 shown in FIG. 3 illustrates a possible physical route that could be used by an employee to execute plurality of tasks 134 using proposed sequence 126. An employee using route 144 would start at BEGIN 146, completing task 1 at location indicator 311, and travel to each of plurality of location indicators 140 as shown by route 144 in FIG. 3, completing each of plurality of tasks 134 at its corresponding location indicator 140, until task 6 is completed at location indicator 334, at END 148 of route 144. Along the way employee 104 records a time stamp using mobile computing device 106 at each location indicator 140 after each one of plurality of tasks 134 is complete. Each time stamp is a part of task performance data 136 and provides to system 110 the time each one of plurality of tasks 134 is completed.

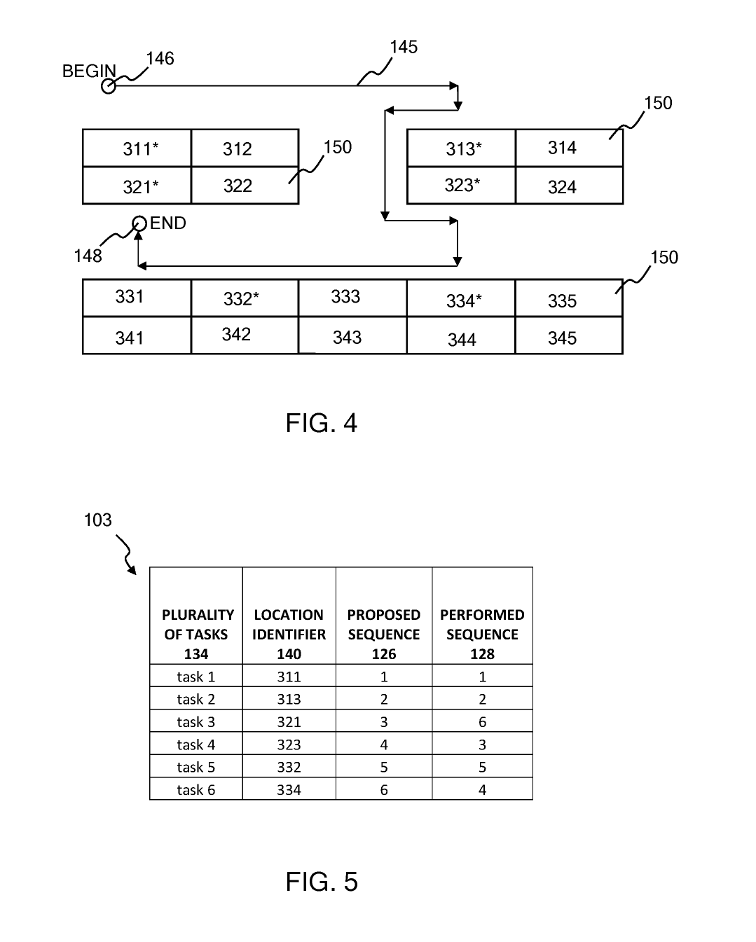

The problem is that proposed sequence 126 and route 144 may not be the optimal route to use to complete plurality of tasks 134. Proposed sequence 126 may have a travel time between tasks that is too long, it may be less safe than other possible routes, or it may have other potential issues. What is needed is a method and system for optimizing proposed sequences 126 given to employees for completing plurality of tasks 134. The disclosed system and method for determining a sequence for a plurality of tasks provides proposed sequence 126 to an employee as part of sequenced task list 103. The employee is instructed to complete the tasks using a time-efficient and safe route. FIG. 4 and FIG. 5 illustrate a route 145 and a performed sequence 128 that was used by an employee to perform plurality of tasks 134. Route 145 and performed sequence 128 minimizes the time and distance traveled by the employee completing plurality of tasks 134. Route 145 is a shorter route, as can be seen by comparing route 145 of FIG. 4 to route 144 of FIG. 3. FIG. 5 shows both proposed sequence 126, which puts location indicators 140 in numerical order, and performed sequence 128, which is not in numerical order of location indicator. As explained herein below, the disclosed system and method for determining a sequence for a plurality of tasks collects performed sequence 128 and uses performed sequence 128 to generate proposed sequences 126 for future sequenced task lists 103, when the tasks to be performed are in the same or similar location indicators 140 as plurality of tasks 134 of FIG. 2 through FIG. 5.

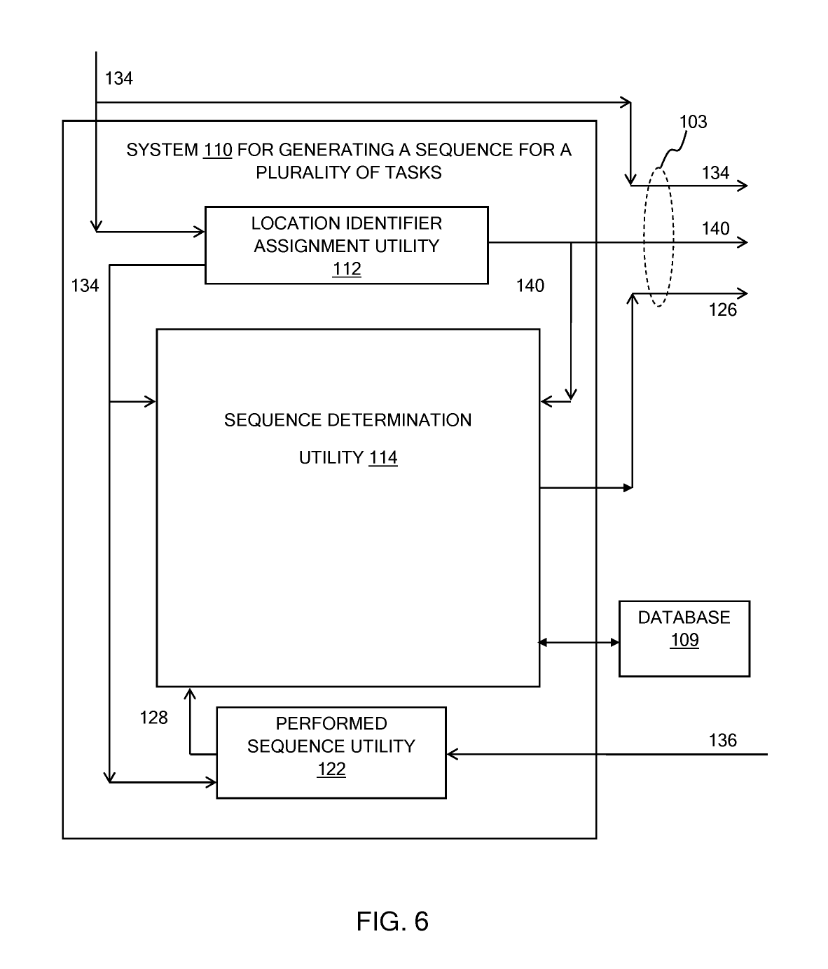

FIG. 6 shows an embodiment of a system 110 for generating a sequence for a plurality of tasks. System 110 in the embodiment shown in FIG. 6 accepts as input plurality of tasks 134 as shown in example form in FIG. 1 through FIG. 4. Plurality of tasks 134 can be any number and combination of tasks for an employee to complete. The specific tasks comprising plurality of tasks 134 are determined and input to system 110 by an employer, for example, and consist of the tasks a particular employee are to complete. System 110 outputs sequenced task list 103 in response to receiving plurality of tasks 134. Sequenced task list 103 includes the location identifier 140 associated with each one of plurality of tasks 134, and a proposed sequence 126 for plurality of tasks 134, as shown in FIG. 2.

System 110 includes a location identifier assignment utility 112, a sequence determination utility 114, and a performed sequence utility 122. A “utility”, as used in this document, can be a circuit, a software program, a hardware apparatus, an application specific integrated circuit, a special purpose computer, or a combination of hardware and software circuits, systems, or implementations. A utility can be any element, thing, or program that accepts one or more input and provides one or more output. System 110 in this embodiment is a computer implemented system, but this is not meant to be limiting. System 110 can be implemented in hardware, firmware, software, or any combination of these. In a particular embodiment, location identifier assignment utility 112, sequence determination utility 114, and performed sequence utility 122 are each implemented as an application specific integrated circuit. In another specific embodiment, location identifier assignment utility 112, sequence determination utility 114, and performed sequence utility 122 are each implemented as a hardware processor. In some embodiments, each hardware processor is a hardware accelerator that interfaces with a computer program. In some embodiments, each hardware processor is a part of one or more special purpose computer that executes computer program instructions.

Location identifier assignment utility 112 receives plurality of tasks 134 as input. Location identifier assignment utility 112 associates a location identifier 140 to each one of plurality of tasks 134. Location identifier assignment utility 112 outputs plurality of tasks 134 and the corresponding location identifier 140 for each of plurality of tasks 134, as shown in example format in FIG. 2. Location identifier assignment utility 112 may be implemented in hardware, firmware, software, or any other implementation.

Sequence determination utility 114 is coupled to location identifier assignment utility 112, and receives plurality of tasks 134 and associated location identifiers 140 from location identifier assignment utility 112. Sequence determination utility 114 generates and outputs proposed sequence 126 for plurality of tasks 134.

Sequence determination utility 114 can use many different methods to generate proposed sequence 126. Some of the systems and methods for generating proposed sequence 126 are shown and described herein. In some embodiments, sequence determination utility 114 will use performed sequences 128 used in the past by employees for tasks at the same or nearby location identifiers 140 to generate proposed sequence 126. A performed sequence 128 is a sequence used by an employee to perform a plurality of tasks. Continuing the example embodiment from FIG. 1 through FIG. 4, plurality of tasks 134 is a first plurality of tasks 134. In this embodiment, there are no performed sequences 128, or history of past performance of performing plurality of tasks 134 at the associated location identifiers 140, to use in generating proposed sequence 126. Thus, in this example embodiment, sequence determination utility 114 generates proposed sequence 126 by putting location identifiers 140 in numeric order, as shown in FIG. 2. In this embodiment, sequence determination utility 114 uses the location identifier 140 associated with each one of first plurality of tasks 134 to generate proposed sequence 126.

Proposed sequence 126 is given to employee 104 as a suggested sequence for performing first plurality of tasks 134. Employee 104 performs first plurality of tasks 134 in proposed sequence 126, or in a different sequence if they believe a different route is better. Continuing the example from FIG. 1 through FIG. 4, employee 104 completes first plurality of tasks 134 using route 145 of FIG. 4 and performed sequence 128 of FIG. 5. Employee 104 generates task performance data 136, which in this embodiment includes a time stamp representing the time each one of plurality of tasks 134 is completed, while performing first plurality of tasks 134. Task performance data 136 is used by system 110 to optimize proposed sequences 126 for a second or other future plurality of tasks 134 that are to be performed at the same location identifiers 140, or nearby location identifiers 140.

System 110 for generating a sequence for a plurality of tasks includes performed sequence utility 122. Performed sequence utility 122 receives task performance data 136 generated by employee 104 performing first plurality of tasks 134. Performed sequence utility 122 generates performed sequence 128, the actual sequence used by employee 104 to perform first plurality of tasks 134, in response to receiving task performance data 136. Performed sequence utility 122 is coupled to sequence determination utility 114 and provides performed sequence 128 to sequence determination utility 114.

Performed sequence utility 122 can compute performed sequence 128 in many different ways, depending on the type of data obtained from task performance data 136. Continuing the earlier example, task performance data 136 includes time stamps indicating when each one of first plurality of tasks 134 is completed by employee 104. The time stamps are used by performed sequence utility 122 to generate performed sequence 128 as shown in FIG. 5. Performed sequence utility 122, in this example, will put plurality of tasks 134 in numerical order of the time stamps received in task performance data 136. In this example, employee 104 using route 145 to complete plurality of tasks 134 will generate a performed sequence 128 as shown in FIG. 5.

In some embodiments, task performance data 136 includes the performed sequence 128, and performed sequence utility 122 does not have to calculate performed sequence 128 from time stamps, but merely passes performed sequence 128 to sequence determination utility 114. For example, in some embodiments, employee 104 will directly enter into computer 108 or other data entry device the performed sequence 128 they used to perform plurality of tasks 134. Task performance data 136 can include many different types of data collected in response to the performance of a plurality of tasks 134. Task performance data 136 can include data relating to the safety of a specific route or sequence as well as the timing, or can include data relating to other factors that are desired to be collected by an employer as employee 104 performs plurality of tasks 134.

Sequence determination utility 114 uses performed sequence 128, the sequence actually used by employee 104 to perform first plurality of tasks 134, to generate a proposed sequence 126 for a second plurality of tasks 134. For each proposed sequence 126 provided to an employee, task performance data 136 is collected and used by system 110 and sequence determination utility 114 to generate new proposed sequences 126 for later plurality of tasks 134 that are to be completed.

Sequence determination utility 114 can use performed sequence 128 in many different ways to determine a second proposed sequence 126. In some embodiments sequence determination utility 114 compares performed sequence 128 to proposed sequence 126. If performed sequence 128 is different than proposed sequence 126, second proposed sequence 126 is set equal to performed sequence 128. In this example, system 110 is assuming that performed sequence 128 as used by the employee is a better sequence than proposed sequence 126, and so uses performed sequence 128 instead.

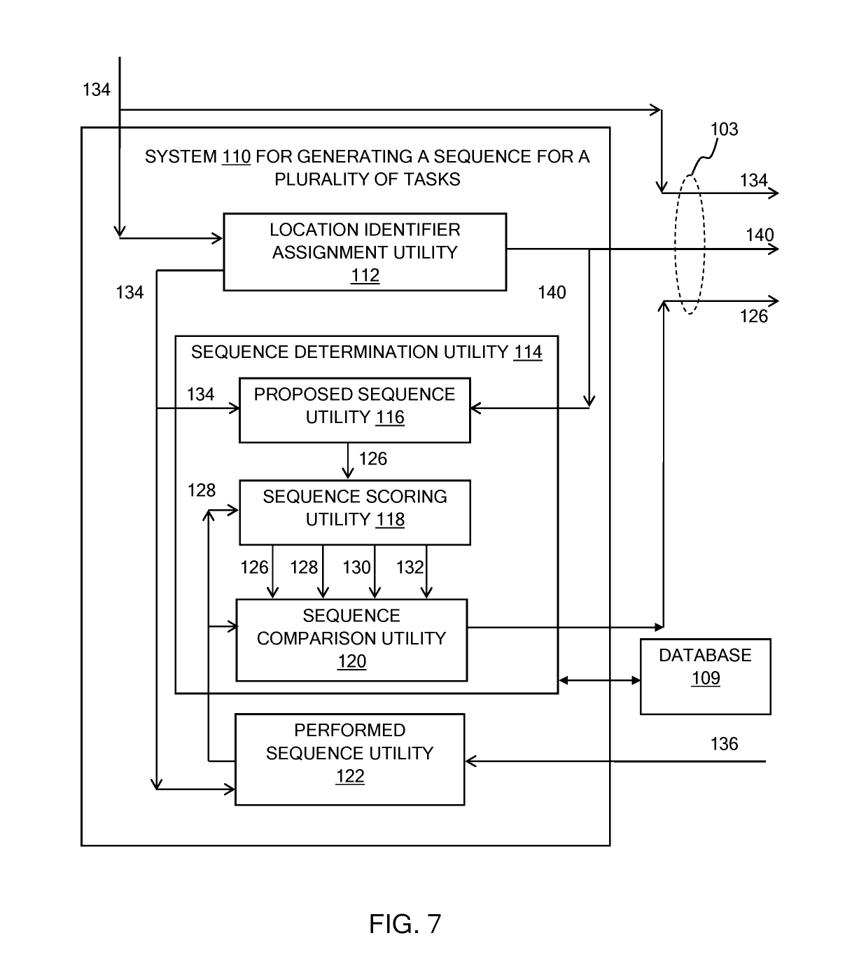

In some embodiments, sequence determination utility 114 uses a system of scoring sequences and then comparing the sequences. This allows a number of factors to be taken into account when determining which sequence to use. FIG. 7 illustrates an embodiment of sequence determination utility 114 which includes a sequence scoring utility 118, and a sequence comparison utility 120.

Sequence scoring utility 118 is coupled to proposed sequence utility 116, and receives proposed sequence 126 from proposed sequence utility 116. Sequence scoring utility 118 is coupled to performed sequence utility 122, and receives performed sequence 128 from performed sequence utility 122. Sequence scoring utility 120 generates a proposed sequence score 130, and a performed sequence score 132, and outputs proposed sequence 126, proposed sequence score 130, performed sequence 128, and performed sequence score 132 to sequence comparison utility 120.

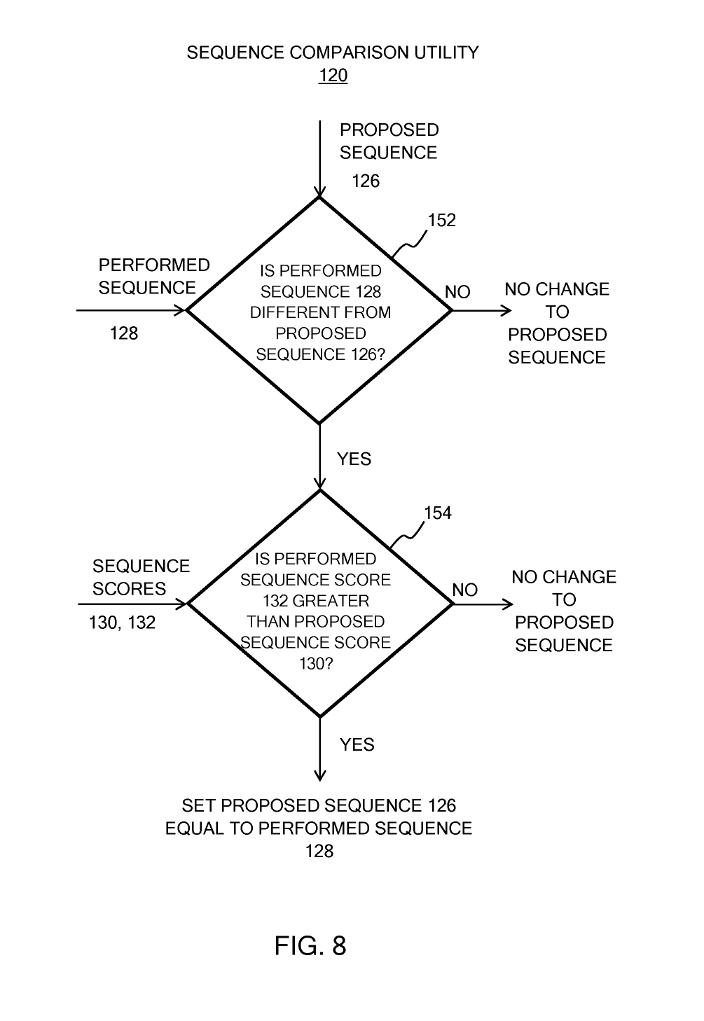

Sequence comparison utility 120 can compare sequences and scores in many different ways. One example embodiment of the algorithm used by sequence comparison utility 120 of FIG. 7 to compare sequences and scores is shown in FIG. 8. In this embodiment, sequence comparison utility 120 compares proposed sequence 126 and performed sequence 128 at decision block 152. If performed sequence 128 is not different from proposed sequence 126, there is no change to proposed sequence 126, and proposed sequence 126 is output from system 110 and given to an employee with plurality of tasks 134 and associated location identifiers 140. If performed sequence 128 is different than proposed sequence 126, then we move to decision block 154, which compares performed sequence score 132 to proposed sequence score 130. At decision block 154, if proposed sequence score 130 is greater than performed sequence score 132, there is no change to proposed sequence 126, and proposed sequence 126 is output from system 110 and given to an employee with plurality of tasks 134 and associated location identifiers 140. If performed sequence score 132 is greater than proposed sequence score 130, proposed sequence 126 is set equal to performed sequence 128 and then output from system 110.

In a specific embodiment, sequence comparison utility 120 is implemented as an application specific integrated circuit which performs the flow chart as shown in FIG. 8. In some embodiments, sequence comparison utility 120 is a part of one or more special purpose computers that execute computer program instructions and implement one or more functions or operations of sequence determination utility 114, including the flowchart as shown in FIG. 8. In another specific embodiment, sequence comparison utility is implemented in hardware accelerators that are coupled to software and execute specific software commands.

Sequence determination utility 114 can use one or many performed sequences 128 to generate a new proposed sequence 126. Task performance data 136 is collected from all performed sequences 128, and are available for use to generate proposed sequences 126. Performed sequences 128 for pluralities of tasks 134 that have the same location identifiers as a new proposed sequence 126 will be used as the one or more performed sequences 128 for comparison to the proposed sequence 126. In addition, performed sequences 128 used for comparison do not have to have exactly the same location identifiers. Adjacencies can be used to determine which performed sequences 128 will be used for comparison. For example, if a proposed sequence 126 has a task with a location identifier of 314 associated with it (See FIG. 3), performed sequences that are the same except having a task with a location identifier of 313 can be used, because by taking into account the physical layout of shelves 150, it is knows that location identifier 314 is near location identifier 313. Thus, physical characteristics of the store, warehouse, or shelves 150 can be used to determine adjacencies, and which performed sequences 128 are to be used to compare to a particular proposed sequence 126.

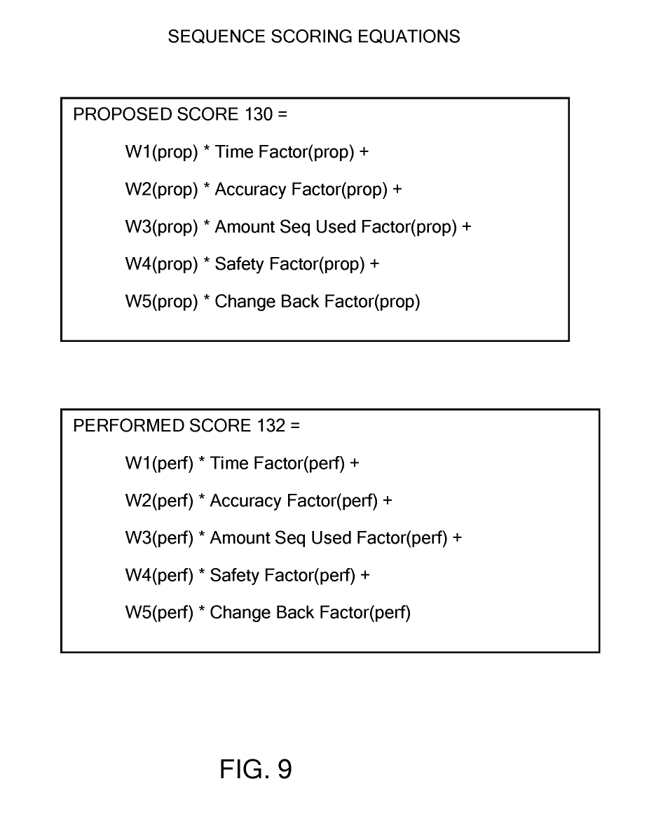

Sequence scoring utility 118 can score proposed sequence 126 and performed sequence 128 in many different ways, depending on the particular scoring technique and priorities determined by an employer. FIG. 9 shows example scoring equations that can be used for proposed score 130 and performed score 132. It is to be understood that these specific scoring equations are examples only, and are not meant to be limiting. Many different scoring techniques and equations can be used.

In the embodiment shown in FIG. 9, each score is the addition of a number of different factors, each multiplied by a weight. Thus, proposed score 130 and performed score 132 are each computing by adding together a plurality of weighted factors. Each factor provides a scoring value for a factor that an employer wants considered in scoring sequences.

In the scoring equation embodiments shown in FIG. 9, each scoring equation includes a time factor. The time factor is equal to the total travel time between time stamps collected for previous performed sequences 128 with the same sequence and the same or adjacent location identifiers as the current proposed sequence 126 or performed sequence 128. Therefore, the time factor is an estimate, based on past sequences, of the travel time it would take to complete a route using a particular sequence. In this embodiment the time factor is the reciprocal of the total travel time between time stamps obtained at each location identifier. The time factor being the reciprocal of the total travel time between time stamps indicates that faster total time for a sequence is better, in other words smaller total travel time between time stamps will result in a higher time factor and a higher score.

For example, for proposed sequence score 130 of FIG. 9, the time factor (prop) is the reciprocal of the total travel time between time stamps, or

Time Factor(prop)=1/total travel time(prop);

where total travel time(prop) is the total travel time between time stamps from one or more than one performed sequence 128 that had tasks at the same or similar location identifiers as proposed sequence 126, and the same sequence as proposed sequence 126. If there are a number of performed sequences that are suitable for use in determining the total travel time(prop) for a particular proposed sequence 126, their travel times will be summed and averaged in a way to get total travel time(prop). If there is a particular proposed sequence 126 where there is no data from earlier sequences to use for time factor(prop) or any of the factors in proposed score 130, default values can be used, or proposed sequence 126 can be determined by putting the location indicators in numerical order, as mentioned earlier.

For performed sequence score 132 of FIG. 9, the time factor (perf) is the reciprocal of the total travel time between time stamps, or

Time Factor(perf)=1/total travel time(perf);

where total travel time(perf) is the total travel time between time stamps from one or more than one performed sequence 128 that had tasks at the same or similar location identifiers as performed sequence 128, and the same sequence as performed sequence 128. If there are a number of performed sequences that are suitable for use in determining the total travel time(perf) for a particular performed sequence 128, their travel times will be summed and averaged to get total travel time(perf).

The accuracy factor, for both proposed sequence score 130 and performed sequence score 132, is a value indicating, for a particular sequence, the percentage that the route was found to be accurate. A particular sequence is deemed more accurate if more employees use that particular sequence. If there is no history to use, the accuracy factor will be given a beginning default value until data is available.

The amount sequence used (Amount Seq Used) factor, for both proposed sequence score 130 and performed sequence score 132, indicates, for a particular sequence, the percentage of a previous proposed sequence that was used. If there is no history to use, the amount sequence used factor will be given a beginning default value until data is available.

The safety factor, for both proposed sequence score 130 and performed sequence score 132, indicates the relative safety of a particular sequence. The safety factor is the percentage of time that an employee would create a safe route using a particular sequence. The safety factor allows low scores to be given for taking unsafe routes. For example, and again referring to FIG. 3, if a performed sequence 128 indicated too short a travel time between time stamps obtained at location identifiers 333 and 343 successively, it could indicate an employee crawling through the shelves instead of walking around the end of the rows. This particular sequence would get a low score for a safety factor. If there is no history to use, the safety factor will be given a beginning default value until data is available. Unsafe routes can be determined in many different ways. In one embodiment, if the time between time stamps is outside of 5 sigma, meaning the time between tasks is statistically too short, then it can be determined that the employee either ran or crawled through shelves, and this sequence would be given a low safety factor. In some embodiments, sequence audits can be performed where a person walks a sequence and route, and assign a safety score to the sequence.

The change back factor, for both proposed sequence score 130 and performed sequence score 132, is a factor that indicates if an employee has reverted back to an earlier proposed sequence. If an employee determines that an earlier proposed sequence is better, this is given consideration in a higher change back factor. If there is no history to use, the change back factor will be given a beginning default value until data is available.

Each of the factors is multiplied by a weight. The weights are assigned by users of system 110 and allow the user to choose how important each factor is in the score. As mentioned earlier, in some instances, a particular proposed sequence 128 may not have any earlier performed sequences 128 to obtain data from to compute a proposed score 130. In these cases default values can be assigned to factors and the sequence.

Provided are two examples of score computations, given as examples only of the possible scores, factors, and weightings,

### EXAMPLE 1

In example 1, the employer is putting a high weight on the time factor, indicating that quicker sequences are better. In this example W1(prop) and W1(perf) are each 100,000, and each of the other weights are set equal to 1:

W1(prop)=W1(perf)=100,000;

and

$$W 2 ( prop ) = W 2 ( perf ) = W 3 ( prop ) = W 3 ( perf ) = W 4 ( prop ) = W 4 ( perf ) = W 5 ( prop ) = W 5 ( perf ) = 1.$$

The factors for Example 1 have values of:
Time factor (prop)= 1/600;
Accuracy Factor(prop)=80;
Amount Seq Used Factor(prop)=100;
Safety Factor(prop)=100;
Change Back Factor(prop)=100;
Time factor (perf)=1/800;
Accuracy Factor(perf)=100;
Amount Seq Used Factor(perf)=100;
Safety Factor(perf)=100; and
Change Back Factor(perf)=100.

In Example 1, proposed sequence 126 has a shorter time between scans (600 versus 800), indicating proposed sequence 126 is a quicker sequence, but performed sequence 128 has a higher accuracy (100 for performed sequence 128, 80 for proposed sequence 126), indicating performed sequence 128 is more accurate (a greater number of employees used performed sequence 128). Solving for each score, we get:
Proposed score 130=546.57;
   and
Performed score 132=525.

Since the time factor is heavily weighted, proposed score 130 is greater than performed score 132, and proposed sequence 126 would be chosen and used instead of performed sequence 128.

### EXAMPLE 2

In example 2, the employer is putting a high weight on the accuracy factor, indicating that more accurate sequences are better. In this example W2(prop) and W2(perf) are each 4, and each of the other weights are set equal to 1:
W2(prop)=W2(perf)=4;
   and

$$W 1 ( prop ) = W 1 ( perf ) = W 3 ( prop ) = W 3 ( perf ) = W 4 ( prop ) = W 4 ( perf ) = W 5 ( prop ) = W 5 ( perf ) = 1.$$

The factors for Example 2 have values of:
Time factor (prop)= 1/75;
Accuracy Factor(prop)=80;
Amount Seq Used Factor(prop)=100;
Safety Factor(prop)=100;
Change Back Factor(prop)=100;
Time factor (perf)= 1/100;
Accuracy Factor(perf)=100;
Amount Seq Used Factor(perf)=100;
Safety Factor(perf)=100; and
Change Back Factor(perf)=100.

In Example 2, proposed sequence 126 has a shorter time between scans (75 versus 100), indicating proposed sequence 126 is a quicker sequence, but performed sequence 128 has a higher accuracy (100 for performed sequence 128, 80 for proposed sequence 126), indicating performed sequence 128 is more accurate (a greater number of employees used performed sequence 128). Solving for each score, we get:
Proposed score 130=695;
   and
Performed score 132=800.

Since the accuracy factor is heavily weighted, performed score 132 is greater than proposed score 130, and performed sequence 128 would be chosen and used instead of proposed sequence 126.

It is to be understood that the scoring equations described and shown in FIG. 9 are examples only, and many different types of scoring equations and factors and weights can be used, depending on the priorities of an employer and the different considerations that need to be taken into account when comparing different sequences. Proposed score 130 equations and performed score 132 equations as shown in FIG. 9 can be implemented in software, hardware such as application specific integrated circuits, or firmware. In a specific embodiment, proposed score 130 equations and performed score 132 equations as shown in FIG. 9 are a part of one or more special purpose computers that execute computer program instructions and implement one or more functions or operations of sequence determination utility 114, including the proposed score 130 equations and performed score 132 equations as shown in FIG. 9. In another specific embodiment, proposed score 130 equations and performed score 132 equations as shown in FIG. 9 are implemented in hardware accelerators that are coupled to software and execute the scoring equations.

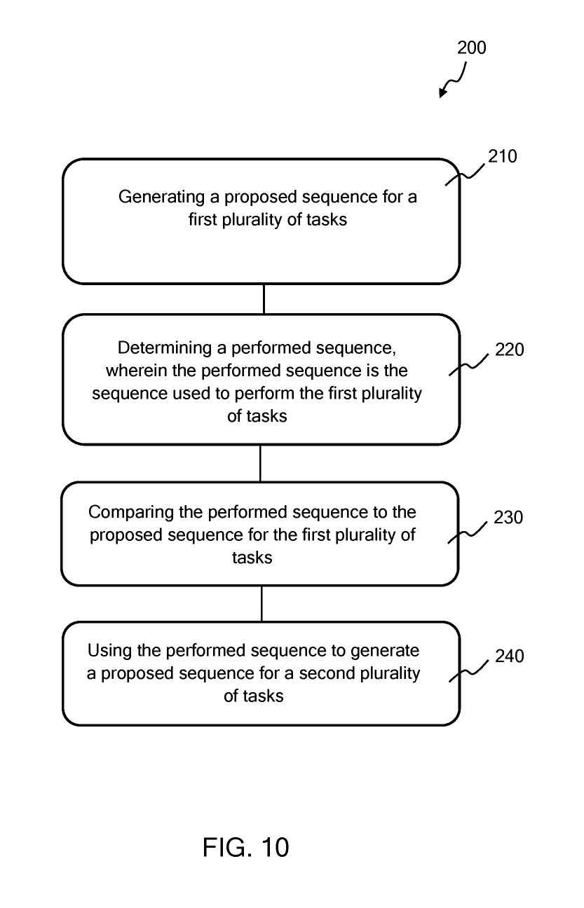

FIG. 10 illustrates method 200 of generating a sequence for a plurality of tasks. Method 200 includes element 210 of generating a proposed sequence for a first plurality of tasks. Method 200 of generating a sequence for a plurality of tasks includes element 220 of determining a performed sequence, wherein the performed sequence is the sequence used to perform the first plurality of tasks. Method 200 also includes element 230 of comparing the performed sequence to the proposed sequence for the first plurality of tasks, and element 240 of using the performed sequence to generate a proposed sequence for a second plurality of tasks. Method 200 of generating a sequence for a plurality of tasks can include many other elements. In some embodiments, method 200 includes assigning a location identifier to each of the first plurality of tasks.

Element 210 of generating a proposed sequence for a first plurality of tasks can include many other elements. In some embodiments, generating a proposed sequence for a first plurality of tasks includes putting the location identifiers assigned to each of the first plurality of tasks in numerical order.

Element 220 of determining a performed sequence can include many other elements. In some embodiments, determining a performed sequence includes collecting a time stamp for each of the first plurality of tasks. In some embodiments, determining a performed sequence includes using the time stamps to compute a total travel time between time stamps for the first plurality of tasks. In some embodiments, determining a performed sequence includes computing a time factor by inverting the total travel time between time stamps for each of the first plurality of tasks.

Element 230 of comparing the performed sequence to the proposed sequence for the first plurality of tasks can include many other elements. In some embodiments, comparing the performed sequence to the proposed sequence comprises assigning a proposed sequence score to the proposed sequence. In some embodiments, assigned a proposed sequence score include assigning a default value to the proposed sequence score. In some embodiments, assigning a proposed sequence score comprises summing a plurality of proposed sequence weighted factors. In some embodiments, assigning a proposed sequence score to the proposed sequence comprises computing a time factor. In some embodiments, the time factor in the inverse of the total travel time between time stamps for the first plurality of tasks. In some embodiments, assigning a proposed sequence score to the proposed sequence comprises computing an accuracy factor. In some embodiments, assigning a proposed sequence score to the proposed sequence comprises computing the percentage that the proposed sequence matched earlier proposed sequences. In some embodiments, assigning a proposed sequence score to the proposed sequence comprises computing the amount the proposed sequence has been used. In some embodiments, assigning a proposed sequence score to the proposed sequence comprises computing a safety factor for the proposed sequence. In some embodiments, assigning a proposed sequence score to the proposed sequence comprises computing a change back factor for the proposed sequence. In some embodiments, assigning a proposed sequence score to the proposed sequence comprises computing the percentage that the proposed sequence was accurate as compared to earlier proposed sequences. In some embodiments, other factors are generated and used in the computation of the proposed sequence.

In some embodiments, element 230 of comparing the performed sequence to the proposed sequence further comprises assigning a performed sequence score to the performed sequence. In some embodiments, assigning a performed sequence score to the performed sequence comprises summing a plurality of performed sequence weighted factors. In some embodiments, assigning a performed sequence score to the performed sequence comprises computing a time factor. In some embodiments, the time factor in the inverse of the total travel time between time stamps for the first plurality of tasks. In some embodiments, assigning a performed sequence score to the performed sequence comprises computing an accuracy factor. In some embodiments, assigning a performed sequence score to the performed sequence comprises computing the percentage that the performed sequence matched the proposed sequence. In some embodiments, assigning a performed sequence score to the performed sequence comprises computing the amount the performed sequence has been used. In some embodiments, assigning a performed sequence score to the performed sequence comprises computing a safety factor for the performed sequence. In some embodiments, assigning a performed sequence score to the performed sequence comprises computing a change back factor for the performed sequence. In some embodiments, assigning a performed sequence score to the performed sequence comprises computing the percentage that the performed sequence was accurate as compared to earlier performed sequences. In some embodiments, other factors are generated and used in the computation of the performed sequence.

Element 240 of using the performed sequence to generate a proposed sequence for a second plurality of tasks can include many other elements. In some embodiments, using the performed sequence to generate a proposed sequence for a second plurality of tasks comprises setting the proposed sequence equal to the performed sequence in response to the performed sequence being different than the proposed sequence. In some embodiments, using the performed sequence to generate a proposed sequence for a second plurality of tasks comprises setting the proposed sequence equal to the performed sequence in response to the performed sequence score being greater than the proposed sequence score.

As will be appreciated by one skilled in the art, aspects of the disclosed system and method for determining a sequence for a plurality of tasks may be embodied as a system, method, or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, radio frequencies, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

While the invention has been shown and described with reference to specific preferred embodiments, it should be understood by those skilled in the art that various changes in form and detail may be made therein without departing from the spirit and scope of the invention as defined by the following claims.

What is claimed is:

1. A computer system for determining a sequence for a plurality of tasks comprising:
a sequence determination utility that generates a proposed sequence for performing a first plurality of tasks; and
a performed sequence utility that stores in memory a performed sequence, wherein the performed sequence was used to perform the first plurality of tasks;
wherein the sequence determination utility uses the performed sequence to generate a proposed sequence for performing a second plurality of tasks.

2. The computer system of claim 1, wherein the sequence determination utility uses a location identifier associated with each one of the first plurality of tasks to generate the proposed sequence for the first plurality of tasks.

3. The computer system of claim 1, wherein the sequence determination utility further comprises a sequence scoring utility, wherein the sequence scoring utility assigns a proposed sequence score to the proposed sequence and a performed sequence score to the performed sequence.

4. The computer system of claim 3, wherein the sequence scoring utility computes the performed sequence score by adding together a plurality of weighted factors.

5. The computer system of claim 3, wherein the sequence scoring utility determines the percentage that the performed sequence corresponds to the proposed sequence.

6. The computer system of claim 3, wherein the sequence scoring utility computes the performed sequence score by computing a safety factor for the performed sequence.

7. The computer system of claim 3, wherein the sequence determination utility comprises a sequence comparison utility, and wherein the sequence comparison utility compares the proposed sequence score to the performed sequence score when the performed sequence is different from the proposed sequence.

8. The computer system of claim 7, wherein the sequence comparison utility sets the proposed sequence equal to the performed sequence in response to the performed sequence score being greater than the proposed sequence score.

9. The computer system of claim 1, wherein the sequence determination utility uses the performed sequence to generate a proposed sequence for performing a second plurality of tasks if the performed sequence is different than the proposed sequence for performing the first plurality of tasks.

10. The computer system of claim 1, wherein the performed sequence utility collects a time stamp for each one of the first plurality of tasks, and wherein the performed sequence utility uses the time stamp for each one of the first plurality of tasks to determine the performed sequence.

11. A method of generating a sequence for a plurality of tasks comprising:
generating a proposed sequence for a first plurality of tasks;
determining a performed sequence, wherein the performed sequence was used to perform the first plurality of tasks;
comparing the performed sequence to the proposed sequence for the first plurality of tasks;
and
using the performed sequence to generate a proposed sequence for a second plurality of tasks.

12. The method of claim 11, wherein comparing the performed sequence to the proposed sequence comprises assigning a proposed sequence score to the proposed sequence.

13. The method of claim 12, wherein comparing the performed sequence to the proposed sequence further comprises assigning a performed sequence score to the performed sequence.

14. The method of claim 14, wherein using the performed sequence to generate a proposed sequence for a second plurality of tasks comprises setting the proposed sequence equal to the performed sequence in response to the performed sequence score being greater than the proposed sequence score.

15. The method of claim 14, wherein determining a performed sequence, wherein the performed sequence is the sequence used to perform the first plurality of tasks comprises collecting a time stamp for each of the first plurality of tasks.

16. The method of claim 15, wherein determining a performed sequence, wherein the performed sequence is the sequence used to perform the first plurality of tasks further comprises computing a total travel time between time stamps for the first plurality of tasks.

17. The method of claim 16, wherein determining a performed sequence, wherein the performed sequence is the sequence used to perform the first plurality of tasks further comprises computing a time factor by inverting the total travel time between time stamps for the first plurality of tasks.

18. A system for providing a sequenced task list comprising:
means for assigning a proposed sequence score to a proposed sequence for performing a first plurality of tasks;
means for assigning a performed sequence score to a performed sequence, wherein the performed sequence was used to perform the first plurality of tasks;
and
means for comparing the proposed sequence score to the performed sequence score.

19. The system of claim 18, wherein the means for comparing the proposed sequence score to the performed sequence score sets the proposed sequence equal to the performed sequence in response to the performed sequence score being greater than the proposed sequence score.

20. The system of claim 19, further comprising a means for collecting a plurality of time stamps indicating the time each of the first plurality of tasks is completed.
